(19) United States
(12) Patent Application Publication
(10) Pub. No.: US 2003/0024862 A1
(43) Pub. Date: Feb. 6, 2003

(54) Water filter for ritual bath

(76) Inventor: Yosef Gal, Yahud (IL)

Correspondence Address: William H. Dippert, Esq., Reed Smith LLP, 29th Floor, 599 Lexington Avenue, New York, NY, 10022-7650, US

(21) Appl. No.: 10/206,285

(22) Filed: Jul. 26, 2002

(30) Foreign Application Priority Data
Aug. 1, 2001 (IL) 144682

(51) Int. Cl. B01D 17/12

(52) U.S. Cl. 210/121; 210/169; 210/242.1; 15/1.7

(57) ABSTRACT

A filtering system for cleaning a pool. The system including a casing for immersing in the pool, and at least one filtering unit located within the casing. The floor of the pool or an appendage thereto define at least one chamber together with the casing.

### FIELD OF THE INVENTION

The present invention relates generally to water filtering systems, and in particular, to water filtering systems uncompromisingly suitable for Jewish ritual baths.

### BACKGROUND OF THE INVENTION

One major Jewish purification method involves immersing in a “Mikve”. The “Mikve” is a ritual bath (or small pool) in which at least some of the water originates directly from a natural source without entering any type of detached container. An average “Mikve” contains between about 1000-2000 liters of water and may have dozens or even hundreds of people immerse in it daily. Thus, the water in the “Mikve” collects human debris a large part of which floats on the water. In order to keep the Mikve clean and uncontaminated, chlorine is added to the Mikve in large doses and at least part of the water is replaced as often as possible. Filtering systems commonly used in swimming pools are not generally employed in the Mikve, due to religious requirements. Three major religious requirements are:

1) the filtering system does not have any internal container;

2) the filtering system does not take any of the water out of the Mikve; and

3) the water in the filtering system is in continuous contact with the water of the Mikve with a contact surface of at least a minimal defined area throughout the entire filtering system.

The forbidden internal container referred to above, is not necessarily intended to be a container. In order to qualify as a container, a structure must have a base without holes, and surrounding walls of at least a marginal height, for example, 1 mm. Thus, a ditch carved in a part of the filtering system is considered a container. Also, the base and walls of the container do not have to be built of a single continuous piece, and they may be formed of two or more separate pieces. Modern manufacturing techniques inadvertently produce at least one container in substantially every filtering system not planned specifically for a Mikve. Commonly, containers are defined in a handle used to remove an inner filter and in contact points between the inner filter and the filtering system. One filtering system available for swimming pools but not suitable for a “Mikve” is a system named “Inside skimmer” manufactured by “Sky pool”, Barcelona, Spain. This system is immersed inside a pool such that its top end is beneath the water level of the pool. Water from the pool is turbulated through the top end of the system and is passed through an internal filter cartridge.

Some of the above requirements may be considered non-essential by some of the Jewish law experts, but in order for a filtering system to be employed in a large number of Mikves it must receive the approval of most of the dominant experts, and therefore must adhere to all three requirements.

Many unsuccessful attempts have been made to manufacture a filtering system suitable for a Mikve. A recent attempt involves a system which injects ozone into the water of the Mikve. A sponge placed within a through casing is used to remove dirt from the water. However, the sponge is not sufficient to clean the water of a Mikve in which dozens of people immerse daily. In addition, some Jewish law experts disapprove of use of sponges within the Mikve.

Another system employed to clean a “Mikve” includes a corrugated paper filter which is pressed against the bottom of the “Mikve”. The paper filter does not have a bottom end-piece which ordinary holds the paper in place and is not placed in a casing so that a container is not formed. A Venturi mechanism is used to suck water through the filter. However, when the Venturi pressure is relaxed, or when the filter is lifted to be replaced, the dirt caught within the filter dissipates back into the Mikve. In order to minimize the dissipation of the dirt, a trained Mikve operator must immediately put the filter into a proper net or screen which is used to remove the filter with most of the dirt. It is noted that the second requirement mentioned above requires that also when the filter is removed from the Mikve for replacement substantially no water is taken out with it.

### SUMMARY OF THE INVENTION

An aspect of some embodiments of the present invention relates to a filtering system immersed in a Mikve, which has a tube connecting the interior of the filtering system to a floor of the Mikve. The connecting tube optionally has a diameter of at least 4.5 centimeters, disqualifying the filtering system from being a container.

In some embodiments of the invention, the filtering system comprises a casing tube which has an interior filter cartridge placed therein. Optionally, the filtering system includes a plurality of chambers, for example, a first chamber holding water before it passes through the filter cartridge and a second chamber holding filtered water after passing through the filter cartridge. In some embodiments of the invention, the filtering system includes respective tubes connecting to the floor of the Mikve, for each of the chambers.

In some embodiments of the invention, the connection of the tube to the floor is such which prevents water entering the tube from the Mikve. Optionally, a rock is attached to the floor of the Mikve and the floor-connection tube is attached to the rock. In some embodiments of the invention, an isolation ring is used in connecting the floor-connection tube to the rock and/or floor. Thus, in some embodiments, the tube may have no function aside from providing a fluid connection between the chamber and the floor.

An aspect of some embodiments of the invention relates to placing a propeller of a filtering system in an incomplete sleeve. The sleeve is optionally used in order to enhance the suction power of the propeller. In some embodiments of the invention, the incomplete sleeve has at least one hole at the level of the propeller, so that even if the propeller is considered an impervious surface (e.g., due to overlapping blades being viewed as being on a single surface) the sleeve does not include walls which define a container. The at least one hole is optionally large enough for disqualifying containers according to Jewish law.

In some embodiments of the invention, the at least one hole comprises a circumfrential slit. Optionally, the at least one hole spans at least over the height of the propeller, i.e., from the bottom of a lowest blade of the propeller to the top of a upper most blade. Alternatively or additionally, the at least one hole has a minimal size which encompasses a shape which disqualifies containers, e.g., a circle having a diameter of 4.5 centimeters. Further alternatively or additionally, the at least one hole is adjacent an edge of the sleeve.

An aspect of some embodiments of the invention relates to a Mikve filtering system including a propeller whose face area is less than 70% of the area of an enclosing circle of the propeller. In some embodiments of the invention, the propeller has a face area, which is less than 60%, 50% or even 40% of the area of the enclosing circle of the propeller, so that it cannot define a base of a container.

In some embodiments of the invention, the propeller defines, between its blades, a space encompassing at least one circle having a diameter large enough to disqualify containers (e.g., 45 millimeters).

An aspect of some embodiments of the invention relates to a filtering system including a circumfrential float which has at least a portion above the water level when the filtering system is not operative but does not prevent entrance of water to the system, regardless of the operation state of the filtering system. In some embodiments of the invention, the circumfrential float includes higher border areas which are above the water level at least when the filtering system is inoperative and lower border areas which are below the water level regardless of the operation state of the filtering system.

An aspect of some embodiments of the invention relates to a filtering cartridge including a central tube and surrounding folded filter paper. On at least one end, the folded filter paper is not covered by an impervious material, which could serve as a part of a container. The central tube extends beyond the folded filter paper on the at least one end not covered by the impervious material.

In some embodiments of the invention, the at least one end of the filter paper comprises the lower end. Optionally, the at least one end of the filter paper is held by a net which prevents dirt from falling back into a Mikve in which the cartridge is used, while the cartridge is removed from the Mikve.

There is therefore provided in accordance with an embodiment of the present invention, a filtering system for cleaning a pool, including a casing for immersing in the pool, and at least one filtering unit located within the casing, wherein the floor of the pool or an appendage thereto define at least one chamber together with the casing.

Possibly, the casing comprises a vertical tube. Optionally, the at least one filtering unit comprises a cartridge of a folded filter sheet. Optionally, the at least one filtering unit comprises a sack. Optionally, the casing comprises a central unit which houses the at least one filtering unit and at least one tube which connects the central unit to the floor of the pool.

Optionally, the at least one tube comprises a diameter of at least 45 mm. Possibly, the appendage comprises at least one rock fixedly attached to the floor of the pool. Optionally, the floor of the pool or the appendage thereto participates in defining a chamber of filtered water or unfiltered water. Possibly, the portion of the floor of the pool which participates in defining the at least one chamber comprises an area which encloses a circle of a diameter of at least 45 mm.

Optionally, the filtering system includes a propeller which induces flow of water through the casing, so as to filter the water. Optionally, the propeller comprises a vertical-axis propeller.

Optionally, the filtering system includes an enclosure surrounding the propeller which includes at least one hole at the height of the propeller.

Possibly, a lowest portion of the propeller is higher than a lower point of the hole in the enclosure. Optionally, the at least one hole spans over the entire height from the lowest to highest point of blades of the propeller. Optionally, the propeller includes a plurality of blades and wherein the propeller defines at least one space between the blades having a diameter of at least 45 mm. Optionally, a rotation area of the propeller includes substantially the entire body surface of the casing.

In some embodiments of the invention, the propeller comprises a horizontal-axis propeller. Optionally, the filtering system includes a float attached to the top of the casing such that at least a portion of the float is beneath the water level of the pool at substantially all times. Optionally, the float comprises a circumfrential float and wherein the at least a portion beneath the water at substantially all times comprises a border portion.

There is further provided in accordance with an embodiment of the present invention, a filtering system for cleaning a pool, comprising a casing for immersing in the pool, at least one filtering unit located within the casing, a propeller which induces flow of water through the casing, so as to filter the water, and an enclosure surrounding the propeller which includes at least one hole at the height of the propeller.

Optionally, a lowest portion of the propeller is higher than a lower point of the hole in the enclosure. Optionally, the at least one hole spans over the entire height from the lowest to highest point of blades of the propeller. In some embodiments of the invention, the propeller includes a plurality of blades and wherein the propeller defines at least one space between the blades having a diameter of at least 45 mm.

There is further provided in accordance with an embodiment of the present invention, a filtering system for cleaning a pool, comprising a casing for immersing in the pool, at least one filtering unit located within the casing, and a propeller which induces flow of water through the casing, so as to filter the water, wherein the propeller includes a plurality of blades and wherein the propeller defines at least one space between the blades having a diameter of at least 45 mm.

Optionally, the propeller comprises a vertical-axis propeller.

There is further provided in accordance with an embodiment of the present invention, a filtering system for cleaning a pool, comprising a casing for immersing in the pool, at least one filtering unit located within the casing, and a horizontal axis propeller which induces flow of water through the casing, so as to filter the water.

There is further provided in accordance with an embodiment of the present invention, a filtering system for cleaning a pool, comprising a casing for immersing in the pool, at least one filtering unit located within the casing; and a float attached to the top of the casing such that at least a portion of the float is beneath the water level of the pool at substantially all times.

Possibly, the float comprises a circumfrential float and wherein the at least a portion beneath the water at substantially all times comprises a border portion.

There is further provided in accordance with an embodiment of the present invention, a filter cartridge for use in a pool filtering system, comprising a perforated tube, and folded filter paper surrounding the tube, having at least one end not enclosed in a water sealed material, wherein the perforated tube extends beyond the non-sealed end of the filtered paper.

Optionally, the perforated tube extends beyond the non-sealed end of the filtered paper by at least 2 centimeters or by at least 5 centimeters. Optionally, at least one of the filter paper is enclosed in a water sealed material. There is further provided in accordance with an embodiment of the present invention, a filtering system for cleaning a pool, comprising a casing for immersing in the pool, and a cartridge of filtering paper including filtering paper which on at least one end is not enclosed in a water sealed material, wherein at least 50% of the length of the cartridge is within the casing. Optionally, 60%, 70% or even 80% of the cartridge is located in the casing. In some embodiments of the invention, the cartridge is located entirely in the casing.

### BRIEF DESCRIPTION OF THE DRAWINGS

Particular exemplary embodiments of the invention will be described with reference to the following description of embodiments in conjunction with the figures, wherein identical structures, elements or parts which appear in more than one figure are preferably labeled with a same or similar number in all the figures in which they appear, in which:

FIG. 1 is a schematic cross-sectional illustration of a filtering system for use in a Mikve, in accordance with an exemplary embodiment of the present invention;

FIG. 2 is a schematic illustration of a propeller and an enclosure thereof, for use in a filtering system, in accordance with an embodiment of the present invention;

FIG. 3 is a schematic illustration of a propeller for use in a filtering system, in accordance with an embodiment of the present invention;

FIG. 4 is a schematic illustration of a circumfrential float for use in a filtering system, in accordance with an alternative preferred embodiment of the present invention;

FIG. 5A is a schematic illustration of a bottom portion of a filtering system, in accordance with an embodiment of the present invention;

FIG. 5B is a cross-section illustration of the bottom portion of the filtering system of FIG. 5A, in accordance with another embodiment of the present invention; and

FIG. 6 is a schematic illustration of a bottom portion of a filtering system, in accordance with still another embodiment of the present invention.

### DETAILED DESCRIPTION OF EMBODIMENTS

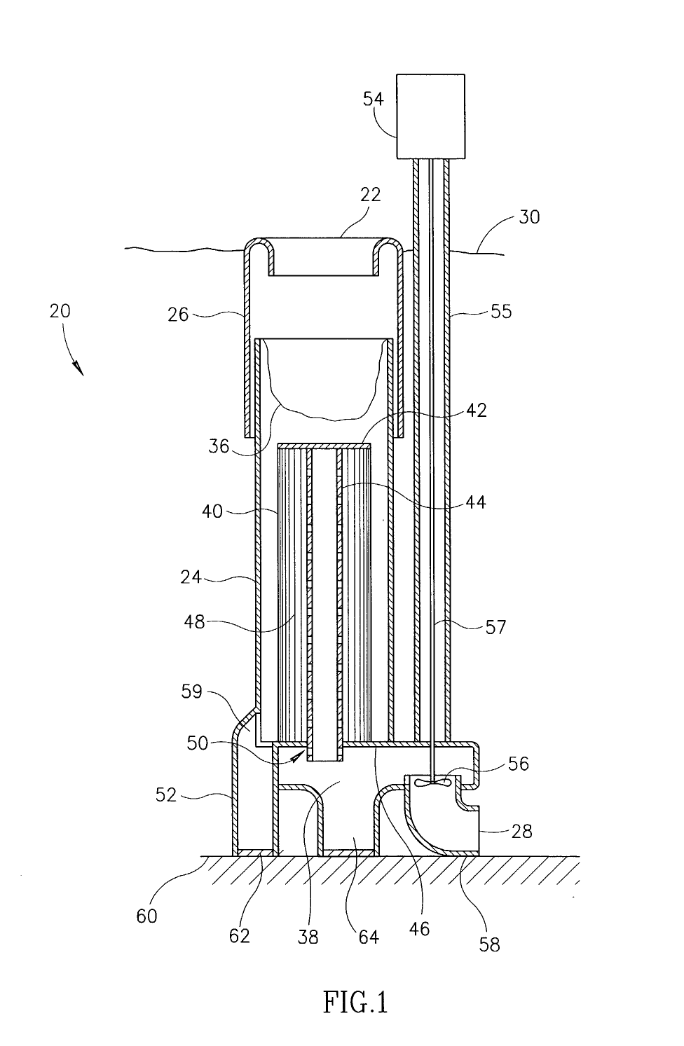

FIG. 1 is a schematic overview of a filtering system 20 for use in a Mikve, in accordance with an embodiment of the present invention. System 20 comprises a casing, optionally formed of an elongated tube 24, in which the water of the Mikve is filtered. The casing optionally further includes a filtered water chamber 38, which receives the filtered water from tube 24 and ejects the filtered water back to the Mikve.

A circumference float 26, as described hereinbelow, is optionally mounted on an upper end of tube 24. Optionally, the water of the Mikve flows into tube 24 through a suction inlet 22 located close to a water level 30 of the Mikve and is returned to the Mikve through a channel 58 leading to an outlet 28 near a floor of the Mikve. In some embodiments of the invention, outlet 28 is at an angle relative to tube 24, in order to enhance the water circulation in the Mikve. In some embodiments of the invention, a filter cartridge 40 within tube 24 filters the water which passes through the tube.

In some embodiments of the invention, a sack 36 is positioned above filter cartridge 40, so as to accumulate coarse dirt from the water entering tube 24. Sack 36 optionally comprises a filtering fabric with a flat outer surface and a shaggy inner surface. An exemplary suitable filtering fabric has a filtering level corresponding to holes of between 2-7 μm. Alternatively, sack 36 comprises a bag of diatomic earth, or of any other suitable filtering material, for example as described in U.S. patent application Ser. No. 09/543,332 to Yosef Gal et al., the disclosure of which is incorporated herein by reference. Sack 36 is optionally removably attached to the upper ends of tube 24, using any method known in the art.

In some embodiments of the invention, tube 24 is fixed to a wall of the Mikve, such that tube 24 does not move during the operation of filtering system 20. Optionally, tube 24 is connected to the wall in a manner which allows easy removal of tube 24 from the Mikve for cleaning thereof. Alternatively or additionally, tube 24 is fixed in place to an anchor point (not shown), outside of the Mikve. Optionally, system 20 is positioned at a corner of the Mikve so as to require only a minimal volume of the Mikve.

System 20 optionally comprises a purification unit (not shown) which provides chlorine or ozone to the Mikve. The purification unit is optionally attached externally to tube 24. In an exemplary embodiment of the invention, the purification unit is an electrolysis unit such as available from Kreepy Krauly, Fla., U.S.

In some embodiments of the invention, filter cartridge 40 comprises a sheet of filter paper 48 folded many folds around a central bore so as to maximize the useful face area of filter paper 48. A perforated central tube 44 optionally runs along the center bore of cartridge 40 leading filtered water out of the cartridge. Optionally, a rigid upper end piece 42 on the top of cartridge 40 holds filter paper 48 in place. End piece 42 optionally comprises a solid water proof material, for example, a plastic, which prevents water from entering central tube 44 without passing through filter paper 48.

Cartridge 40 is optionally placed on an upper surface of chamber 38, referred to herein as a shelf 46. Shelf 46 prevents water entering tube 24 through inlet 22 from exiting through outlet 28 without passing through filter paper 48 of cartridge 40. In addition shelf 46 maintains cartridge 40 in place within tube 24.

Central tube 44 optionally protrudes on its lower end beyond the lower surface of filter paper 48. In some embodiments of the invention, central tube 44 protrudes beyond the lower surface of filter paper 48 by at least 1 centimeter, 3 centimeters or even 5 centimeters, for efficient placement of cartridge 40 on shelf 46. The protruding end of central tube 44 optionally fits precisely into a respective hole 50 in shelf 46. Central tube 44 optionally screws into hole 50 and/or is otherwise fastened to hole 50. In some embodiments of the invention, cartridge 40 does not include a lower end piece. The lower end piece could, in some cases, define a container in areas in which edges of filter paper 48 are encased in the lowed end piece. Alternatively or additionally, a lower end piece could participate in defining a container with shelf 46 and walls of tube 24.

In some embodiments of the invention, tube 24 may be opened on an upper end in order to remove cartridge 40 for cleaning and/or replacement. Optionally, cartridge 40 is removed from the Mikve slowly so as to prevent dirt from falling back into the Mikve, while the cartridge is being removed. Alternatively or additionally, a net (not shown) is fit on the lower end of cartridge 40, so as to catch dirt falling from the cartridge while it is removed from the Mikve. Further alternatively or additionally, a tool with a dustpan bottom end is inserted to tube 24, and positioned beneath filter paper 48, when cartridge 40 is removed from the Mikve.

In some embodiments of the invention, one or more holes 59 are defined at the bottom of tube 24 near shelf 46, so as to prevent tube 24 from defining a container. Holes 59 optionally have a cross section area, sufficient to disqualifies containers, e.g., including a circle with a diameter of at least 45 mm. Optionally, holes 59 are open to the Mikve, allowing water to flow into tube 24 from the interior of the Mikve and not only from the top of the Mikve, through inlet 22. Alternatively or additionally, in order to maximize the amount of water flowing into tube 24 from inlet 22, system 20 comprises one or more tubes 52, which connect holes 59 to the floor 60 of the Mikve, preventing water from entering tube 24 through holes 59. It is noted that according to Jewish law (the floor and rocks attached to the floor) does not participate in defining a container. In some embodiments of the invention, tubes 52 have over their entire length a cross section area encompassing a circle having a diameter of at least 45 mm.

Optionally, tubes 52 lead directly vertically down to floor 60. Alternatively or additionally, one or more of tubes 52 leads diagonally down to floor 60. Optionally, the tube 52 has at substantially every point an angle of at least 15°, 30°, 45° or even 60°, relative to the floor of the Mikve, so as to disqualify tube 52 from forming a container.

Optionally, tubes 52 are fastened around a raised area 62 of floor 60, for example, a rock glued to floor 60. Alternatively, one or more of tubes 52 is glued, hammered or otherwise attached directly to floor 60. Optionally, one or more of tubes 52 comprise a large base surface (not shown) which surrounds the tube at its bottom end and is attached to the floor. Optionally, the large base surface comprises a rubber and/or plastic material. A water proof ring (e.g., an O-ring or other rubber ring) is optionally used in fastening tube 52 to floor 60. Attaching tube 52 to floor 60 is also advantageous in fixing system 20 in place, while minimizing the points of fixation of system 20. In some embodiments of the invention, tube 52 (and optionally tube 64 described below) are the only attachment points of system 20 beneath the water level of the Mikve. In an exemplary embodiment of the invention, system 20 has only a single fixation point other than tube 52 (and optionally tube 64), optionally a point above the water level of the Mikve, e.g., connecting motor 54 (described below) and/or protection cover 55 (described below) to a fixation point outside of the Mikve.

In some embodiments of the invention, tube 52 comprises the same material as tube 24. Optionally, tube 24 and tube 52 are produced as a single piece. Alternatively or additionally, one or more of tubes 52 is detachably attached to tube 24, allowing simpler production and/or installation of system 20. Optionally, one or more of tubes 52 comprises a flexible material which can be folded during transport. Alternatively or additionally, any other materials, optionally water resistant materials, may be used for tubes 52, including rigid materials, which are more durable within the water and/or serve better for anchorage.

In some embodiments of the invention, system 20 comprises only a single tube 52. Alternatively, system 20 comprises two to six tubes 52 distributed, evenly or unevenly, around the circumference of tube 24. Further alternatively, system 20 comprises more than six tubes 52. The use of many tubes 52 removes any resemblance to a container from the area above shelf 46.

In some embodiments of the invention, chamber 38 comprises one or more connections to floor 60 of the Mikve, for example a tube 64, so as to prevent chamber 38 from resembling a container. In some embodiments of the invention, tube 64 has a cross section area sufficient to disqualify containers, e.g., encompassing a circle with a diameter of at least 45 mm. Tube 64 may have any of the above characteristics (e.g., material, number of tubes, connection manner) described in relation to tube 52. In any specific embodiment, the characteristics of tubes 52 and 64 may be the same or different. In some embodiments of the invention, the connection of tube 64 to the floor is more water resistant than the connection of tube 52 to the floor, as water entering chamber 38 through tube 64 is not filtered. Alternatively, the same connection method and/or water resistance level is used for the connections of both tube 52 and 64 to the floor, so as to simplify the installation of the filtering system.

In some embodiments of the invention, a propeller 56 turned by a motor 54, turbulates water into tube 24 from the Mikve. In some embodiments of the invention, motor 54 and propeller 56 turbulate water into tube 24 at a rate of above 60 gallons per minute (GPM), or even above 100 GPM. Thus, in an average sized Mikve (about 600 gallons) system 20 filters on the average substantially all the water in the Mikve about ten times an hour. The rate of water turbulation is generally related to the filtering surface area of cartridge 40 and/or the volume of the Mikve, as is known in the art of water filters.

As shown, propeller 56 is located near outlet 28, while motor 54 is above water level 30, outside of the Mikve. A motor located out of the water is less constrained by safety limitations, for example, can generally use higher voltage levels. It is noted, however, that other propeller-motor arrangements, such as placing the motor within the water, placing the propeller near inlet 22, or any of the arrangements described in above mentioned U.S. patent application Ser. No. 09/543,332, may be used in accordance with the present invention.

In some embodiments of the invention, the rotation axis of propeller 56 is parallel to tube 24, so as to allow direct transfer of rotation power from motor 54 to propeller 56. In an exemplary embodiment of the invention, a rotation axle 57, optionally within a protection cover 55, connects motor 54 to propeller 56.

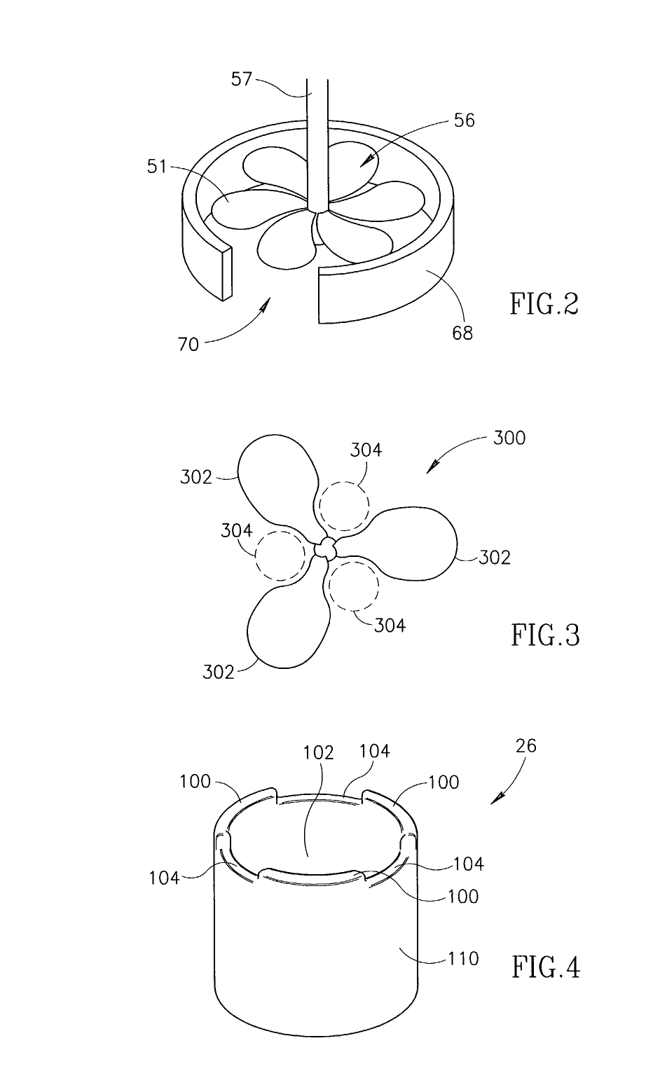

FIG. 2 is a schematic illustration of propeller 56 within an enclosure 68, in accordance with an embodiment of the present invention. As is known in the art, it is desired to locate propeller 56 within an enclosure 68, so as to enhance its operation. On the other hand, propeller 56 may be viewed as a non-perforated surface (i.e., one whose openings are small enough so that the surface is considered continuous under Jewish law), which serves as a bottom surface of a container. In some embodiments of the invention, enclosure 68 includes at least one hole, which prevents blades 51 of propeller 56 from defining a container with the walls of enclosure 68. Optionally, the at least one hole comprises a slit 70 carved in enclosure 68.

In some embodiments of the invention, slit 70 has a width of at least 45 mm, covering a portion of the circumference of enclosure 68 determined according to the size of propeller 56. In an exemplary embodiment of the invention, slit 70 spans over 10°-60° of the circumference of enclosure 68, for example about 30°. In some embodiments of the invention, the height of slit 70 spans from the bottom of the lowest blade 51 of propeller 56 to an upper edge of enclosure 68. Alternatively or additionally, slit 70 spans over the entire height of enclosure 68. Alternatively, for example when enclosure 68 has a height greater than 45 mm, slit 70 spans over a height of at least 45 mm within enclosure 68. Further alternatively or additionally, slit 70 spans from the bottom surface of the lowest blade 51 to the upper surface of the highest blade 51.

Alternatively or additionally to slit 70, enclosure 68 comprises a plurality of small holes which connect the interior of enclosure 68 to the interior of chamber 38. It is noted that in an exemplary embodiment of the invention, slit 70 reduces the effectiveness of propeller 56 by about 10%.

In some embodiments of the invention, enclosure 68 is a stand alone structure separate from channel 58. Alternatively or additionally, enclosure 68 forms a single part with channel 58. Further alternatively or additionally, enclosure 68 is part of a structure which connects to the bottom end of protection cover 55. This structure, which includes enclosure 68, optionally defines large holes which allow flow of water from chamber 38 to channel 58.

In some embodiments of the invention, the bottom of propeller 56 is located at least marginally above the lower surface of chamber 38, so that propeller 56 does not define a container.

In some embodiments of the invention, a large space or hole (e.g., having a diameter of at least 45 mm) is defined between blades 51 and enclosure 68, such that propeller 56 cannot be considered a non-perforated surface.

FIG. 3 is a schematic illustration of a propeller 300 which can be used in system 20, in accordance with an embodiment of the present invention. Propeller 300 comprises three blades 302 which are shaped so as to define a large hole 304 between blades 302. In some embodiments of the invention, propeller 300 is sufficiently large, such that large hole 304 has a diameter of at least 45 mm.

In some embodiments of the invention, propeller 300 rotates in an area which covers the entire bottom portion of chamber 38, such that chamber 38 does not have a bottom surface. In some of these embodiments, tube 64 which connects to chamber 38 to the floor of the Mikve is not used.

Propeller 300 is optionally rotated at a sufficient rate, so as to meet a water turbulation rate desired for the Mikve, according to the size of the Mikve. In order to achieve clean water and prevent development of microorganisms, a sufficiently high rate of water filtering is required, for example such that the water of the Mikve is filtered on the average between every 5-20 minutes, depending on the number of people immersing in the Mikve. Such a rate, for propeller 300, may place high constraints on motor 54. Therefore, in some embodiments of the invention, a smaller propeller than required to define holes 304, a propeller with a greater number of blades (e.g., 5-7 blades) and/or a propeller with a different shape than shown in FIG. 3, is used, so as to provide stronger water flow.

A smaller propeller is also advantageous in reducing the amount of space of the Mikve occupied by filtering system 20. In some embodiments of the invention, when such propellers are used, enclosure 68 is perforated and/or propeller 56 is located above the lower surface of chamber 38, as described above.

In other embodiments of the invention, a propeller with only two blades is used to turbulate the water through a filtering system. Alternatively or additionally, an asymmetrical propeller which defines a hole enclosing a circle of a diameter of at least 45 mm, is used. Using an asymmetrical propeller allows having a larger number of blades while defining a hole of a sufficient size.

Referring back to FIG. 1, in some embodiments of the invention, circumfrential float 26 is fit onto an upper end of tube 24 in a telescopic manner, which allows float 26 to move freely relative to tube 24. Float 26 optionally keeps inlet 22 close to the actual water level 30 of the Mikve, so that the water is induced to flow into tube 24 from the top of the Mikve where fat, hairs and other human debris tends to float.

FIG. 4 is a schematic illustration of circumfrential float 26, in accordance with an embodiment of the present invention. Float 26 optionally comprises a light weight border portion 110 which defines an inner water pass 102, through which water enters tube 24. Border portion 110 optionally has a wavy shape, which includes one or more peaks 100 and one or more shallow areas 104. In some embodiments of the invention, shallow areas 104 are always below water level 30 (FIG. 1) of the Mikve, even when peaks 100 are above the water level, e.g., when water does not flow in through inlet 22. Thus, the water in tube 24 is in substantially continuous contact with the water in the Mikve. Optionally, shallow areas 104 are sufficiently beneath peaks 100, such that the water level of the Mikve is at least 45 mm above shallow areas 104, regardless of the water level of the Mikve, whether a person is in the Mikve and/or regardless of the operation mode of motor 54. In some embodiments of the invention, shallow areas 104 are sufficiently beneath peaks 100, such that the water level of the Mikve is at least 45 mm above shallow areas 104, at substantially all times. Alternatively, the water level of the Mikve is at least marginally above shallow areas 104 and a minimal height of water is not required.

In some embodiments of the invention, the horizontal extent of each of shallow areas 104 is at least 45 mm. Although three shallow areas 104 are shown, any number of shallow areas, symmetrically or non-symmetrically distributed around circumfrential float 26, may be used.

Alternatively or additionally to border portion 110 having peaks 100 and shallow areas 104, in some embodiments of the invention, one or more external floats (not shown) are connected to border portion 110, such that border portion 110 is mostly or entirely at least marginally (optionally at least 45 mm) beneath water level 30. Alternatively or additionally, any other float setup is used to keep inlet 22 close to the water level 30 of the Mikve, with a continuous water connection (optionally having an area encompassing a circle with a diameter of at least 45 mm) between the water within tube 24 and the water in the Mikve.

Alternatively to using a float 26, tube 24 comprises a manually adjusted telescopic tube, which can be adjusted such that inlet 22 is positioned close to the actual water level 30 of the Mikve.

Although channel 58 is shown in FIG. 1 as ejecting water in a direction opposite from tube 64, channel 58 may be pointed in substantially any direction, including towards tube 64. In such cases, outlet 28 is optionally sufficiently large such that the water flows around tube 64.

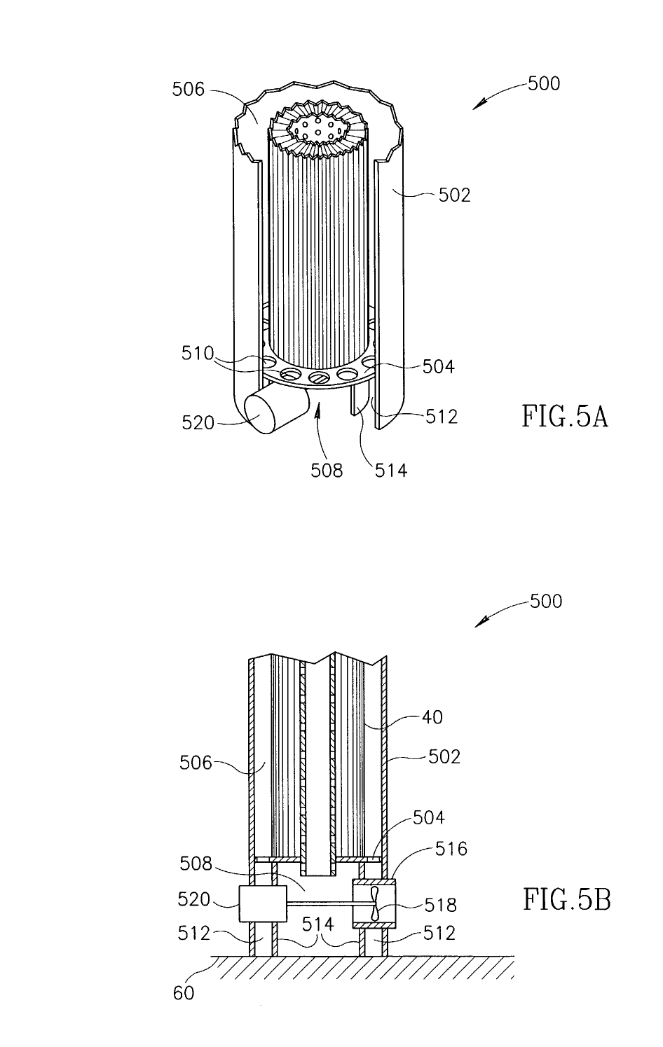

FIGS. 5A and 5B are schematic illustrations of a bottom portion of filtering system 500, in accordance with an embodiment of the present invention. System 500 comprises an external casing tube 502 in which the water of a Mikve is filtered. Tube 502 is optionally placed directly on the floor of the Mikve, so as not to define a container within the Mikve. A shelf 504 separates the interior of tube 502 into an upper chamber 506 and a lower chamber 508. As in system 20, water enters tube 502 from an upper end into upper chamber 506, is filtered by a cartridge 40 and enters lower chamber 508. As lower chamber 508 is open to floor 60, lower chamber 508 does not define a container.

In order to prevent upper chamber 506 from defining a container, the lower area of tube 502 includes, in addition to lower chamber 508, at least one channel area 512, which connects upper chamber 506 to the floor of the Mikve. Optionally, channel area 512 comprise a single area including substantially an entire outer ring of the lower portion of the area defined by tube 502. Walls 514 optionally separate channel area 512 from lower chamber 508. In some embodiments of the invention, one or more large holes 510 (e.g., having a diameter of at least 45 mm) connect upper chamber 506 to channel area 512. Optionally, holes 510 are unobstructed by the filter paper of cartridge 40. Thus, along at least part of the height of upper chamber 506, cartridge 40 is distanced from tube 502 by at least 45 mm. Optionally, cartridge 40 is distanced from the walls of tube 502 by at least 45 mm, along substantially the entire height of tube 502. Alternatively, cartridge 40 is distanced from tube 502 by at least 45 mm, only over a portion of the height of tube 502, optionally over at least 45 mm above shelf 504.

Alternatively to connecting channel area 512 and upper chamber 506 through holes 510, shelf 504 is limited to the area above lower chamber 508 and is attached to tube 502 by one or more thin attachment structures. Thus, channel area 512 is openly connected to upper chamber 506.

In some embodiments of the invention, a horizontal tube 516 connects lower chamber 508 to the Mikve. A propeller 518 having a horizontal rotation axis, optionally located within tube 516, turbulates water from lower chamber 508 to the Mikve. Using a propeller 518 with a horizontal rotation axis removes the problem of defining a container by the propeller.

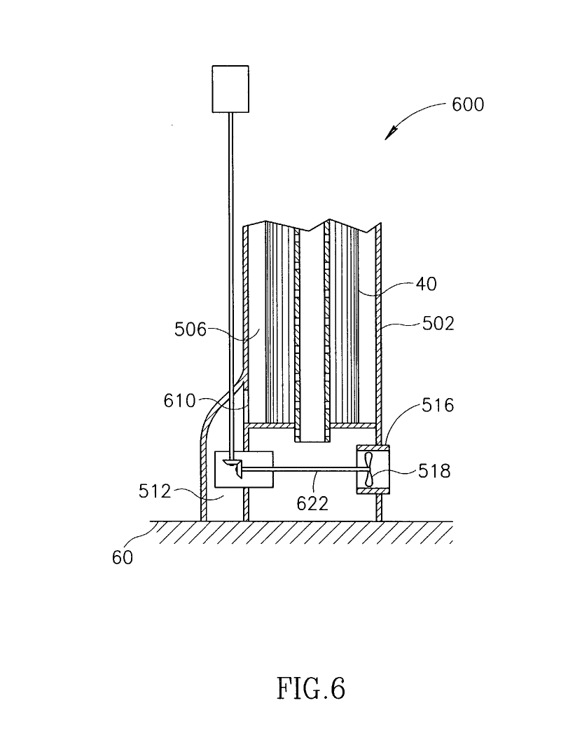

In some embodiments of the invention, propeller 518 is rotated by an underwater motor 520. Optionally, as sown, motor 520 is partially positioned within lower chamber 508, partially within channel area 512 and partially protrudes beyond tube 502 into the Mikve. Alternatively, motor 520 fits within chamber 508 and/or channel area 512. Further alternatively or additionally, propeller 518 is rotated by an external motor located outside of the Mikve. The power of the external motor is optionally passed to propeller 518 through an elastic axle. Alternatively, the external motor is coupled to a vertical axle which is coupled to a horizontal axle of propeller 518 through a suitable set of gears (as shown in FIG. 6).

FIG. 6 is a schematic illustration of a lower portion of a filtering system 600, in accordance with an embodiment of the present invention. System 600 is a variation of system 500 shown in FIG. 5, in which channel area 512 is beyond the boundaries of tube 502. Channel area 512 is optionally connected to upper chamber 506 through one or more vertical windows 610, having at least a size suitable for enclosing a 45 mm diameter circle. In system 600, the distance between tube 502 and cartridge 40 may be less than 45 mm, for example between 5-10 mm in order to allow free flow of water within upper chamber 506.

In some embodiments of the invention, channel area 512 spans over a relatively small portion of the circumference of tube 502, e.g., between 30°-60°, in order to limit the space occupied by system 600. Optionally, channel area 512 does not span over the area in which tube 516 is located, such that tube 516 may be shorter than shown in FIG. 5B. Alternatively, channel area 512 spans over the entire circumference of tube 502. Further alternatively, system 600 includes a pair of channel areas 512 on both sides of tube 516 on the one hand and an axle 622 of propeller 518 on the other hand.

In the above description the length 45 mm was used to define the minimal size required to disqualify a container. It is noted, however, that in Jewish law there are different opinions on the minimal length and/or area which disqualifies containers and more lenient opinions may allow for shorter lengths. The present invention encompasses also systems which use those shorter sizes for disqualifying containers.

Although tube 24 was illustrated as being long and narrow with a circular circumference, other forms, shapes and sizes of tube 24 are within the scope of the present invention. The cross-sectional shape of tube 24 may be rectangular, triangular or of substantially any other shape. Tube 24 may also be thicker, narrower, shorter or longer than that illustrated in the figures. Particularly the diameter of tube 24 may be longer than the height of tube 24. Optionally, the shape of tube 24 is adjusted in order to take up minimal volume of the Mikve. In some embodiments of the invention, tube 24 is round on a side positioned toward the inside of the Mikve and is flat on a side facing the walls of the Mikve.

It will be appreciated that the above described methods may be varied in many ways, including, changing the materials and structures used. For example, instead of horizontal shelves (or other walls), slanted shelves, which lead to holes, may be used. Alternatively or additionally, cartridge 40 is not placed on a shelf but is rather held from above. Further alternatively or additionally, the unfiltered water enters central tube 44 from above and is filtered by passing from tube 44 to the interior of tube 24.

It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A filtering system for cleaning a pool, comprising:
a casing for immersing in the pool; and
at least one filtering unit located within the casing,
wherein the floor of the pool or an appendage thereto define at least one chamber together with the casing.

2. A filtering system as in claim 1, wherein the casing comprises a vertical tube.

3. A filtering system as in claim 1, wherein the at least one filtering unit comprises a cartridge of a folded filter sheet.

4. A filtering system as in claim 1, wherein the at least one filtering unit comprises a sack.

5. A filtering system as in claim 1, wherein the casing comprises a central unit which houses the at least one filtering unit and at least one tube which connects the central unit to the floor of the pool.

6. A filtering system as in claim 5, wherein the at least one tube comprises a diameter of at least 45 mm.

7. A filtering system as in claim 1, wherein the appendage comprises at least one rock fixedly attached to the floor of the pool.

8. A filtering system as in claim 1, wherein the floor of the pool or the appendage thereto participates in defining a chamber of filtered water.

9. A filtering system as in claim 1, wherein the floor of the pool or the appendage thereto participates in defining a chamber of unfiltered water.

10. A filtering system as in claim 1, wherein the portion of the floor of the pool which participates in defining the at least one chamber comprises an area which encloses a circle of a diameter of at least 45 mm.

11. A filtering system as in claim 1, comprising a propeller which induces flow of water through the casing, so as to filter the water.

12. A filtering system as in claim 11, wherein the propeller comprises a vertical-axis propeller.

13. A filtering system as in claim 12, comprising an enclosure surrounding the propeller which includes at least one hole at the height of the propeller.

14. A filtering system as in claim 13, wherein a lowest portion of the propeller is higher than a lower point of the hole in the enclosure.

15. A filtering system as in claim 13, wherein the at least one hole spans over the entire height from the lowest to highest point of blades of the propeller.

16. A filtering system as in claim 12, wherein the propeller includes a plurality of blades and wherein the propeller defines at least one space between the blades having a diameter of at least 45 mm.

17. A filtering system as in claim 12, wherein a rotation area of the propeller includes substantially the entire body surface of the casing.

18. A filtering system as in claim 11, wherein the propeller comprises a horizontal-axis propeller.

19. A filtering system as in claim 1, comprising a float attached to the top of the casing such that at least a portion of the float is beneath the water level of the pool, regardless of an operation mode of the filtering unit.

20. A filtering system as in claim 19, wherein the float comprises a circumfrential float and wherein the at least a portion beneath the water, regardless of the operation mode of the filtering unit comprises a border portion.

21. A filtering system for cleaning a pool, comprising:
a casing for immersing in the pool;
at least one filtering unit located within the casing;
a propeller which induces flow of water through the casing, so as to filter the water; and
an enclosure surrounding the propeller which includes at least one hole at the height of the propeller.

22. A filtering system as in claim 21, wherein a lowest portion of the propeller is higher than a lower point of the hole in the enclosure.

23. A filtering system as in claim 21, wherein the at least one hole spans over the entire height from the lowest to highest point of blades of the propeller.

24. A filtering system as in claim 21, wherein the propeller includes a plurality of blades and wherein the propeller defines at least one space between the blades having a diameter of at least 45 mm.

25. A filtering system for cleaning a pool, comprising:
a casing for immersing in the pool;
at least one filtering unit located within the casing; and
a propeller which induces flow of water through the casing, so as to filter the water,
wherein the propeller includes a plurality of blades and wherein the propeller defines at least one space between the blades having a diameter of at least 45 mm.

26. A filtering system as in claim 25, wherein the propeller comprises a vertical-axis propeller.

27. A filtering system for cleaning a pool, comprising:
a casing for immersing in the pool;
at least one filtering unit located within the casing; and
a horizontal axis propeller which induces flow of water through the casing, so as to filter the water.

28. A filtering system for cleaning a pool, comprising:
a casing for immersing in the pool;
at least one filtering unit located within the casing; and
a float attached to the top of the casing such that at least a portion of the float is beneath the water level of the pool, regardless of an operation mode of the filtering unit.

29. A filtering system as in claim 28, wherein the float comprises a circumfrential float and wherein the at least a portion beneath the water comprises a border portion.

30. A filter cartridge for use in a pool filtering system, comprising:
a perforated tube; and
folded filter paper surrounding the tube, having at least one end not enclosed in a water sealed material,
wherein the perforated tube extends beyond the non-sealed end of the filtered paper.

31. A cartridge according to claim 30, wherein the perforated tube extends beyond the non-sealed end of the filtered paper by at least 2 centimeters.

32. A cartridge according to claim 31, wherein the perforated tube extends beyond the non-sealed end of the filtered paper by at least 5 centimeters.

33. A cartridge according to claim 30, wherein at least one end of the filter paper is enclosed in a water sealed material.

34. A filtering system for cleaning a pool, comprising:
a casing for immersing in the pool; and
a cartridge of filtering paper, including filtering paper which on at least one end is not enclosed in a water sealed material,
wherein at least 50% of the length of the cartridge is positioned in the casing.

35. A system according to claim 34, wherein the cartridge is located entirely in the casing.
